(19) United States
(12) Patent Application Publication
(10) Pub. No.: US 2014/0109886 A1
(43) Pub. Date: Apr. 24, 2014

(54) PULSED POWER SYSTEMS AND METHODS

(71) Applicant: Transient Plasma Systems, Inc., El Segundo, CA (US)

(72) Inventors: Daniel Singleton, El Segundo, CA (US); Jason Sanders, Los Angeles, CA (US); Martin Gundersen, San Garbriel, CA (US); Andras Kuthi, Thousand Oaks, CA (US)

(73) Assignee: Transient Plasma Systems, Inc., El Segundo, CA (US)

(21) Appl. No.: 14/052,437

(22) Filed: Oct. 11, 2013

Related U.S. Application Data
(60) Provisional application No. 61/717,044, filed on Oct. 22, 2012.

(51) Int. Cl. F02P 23/04; H01T 15/00

(52) U.S. Cl. CPC F02P 23/04; H01T 15/00
USPC 123/594; 315/52

(57) ABSTRACT

A system and method for providing pulsed power to improve performance efficiency. In one approach, pulsed power is employed to improve fuel efficiency and power of an engine. The system and method can involve a transient plasma plug assembly intended to replace a traditional spark plug. Alternatively, an approach involving a pulse generator and a nanosecond, high voltage pulse carrying ignition cable is contemplated.

### CROSS-REFERENCE TO RELATED APPLICATION

This application claims the benefit of U.S. Provisional Application No. 61/717,044, filed Oct. 22, 2012, which is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This description relates to pulsed power, and, more particularly, to systems and methods involving pulsed power for improving efficiency of performance of combustion engines.

### BACKGROUND

The electric arc has been the ignition source of choice for most types of propulsion and automotive combustion engines for over 100 years. The electric arc has many features including simplicity, low cost, size and weight of the electronics and it produces sufficiently high temperatures to dissociate and partially ionize most fuel and oxidant molecules. Nevertheless, there are also numerous disadvantages of arc discharges, including the limited size of the discharge, the necessity for supporting electrodes that may interfere with the flow or combustion process, and the low “wall-plug” efficiency (i.e., the ratio of energy deposited in the gas to the electrical energy consumed in producing the discharge). For these reasons, research into the ignition of deflagrations and detonations by alternate energy sources, such as lasers, have been conducted in recent years. However, laser ignition sources present practical difficulties, especially the need for reliable optical access, extremely low wall-plug efficiency, and high optical intensities needed to induce breakdown in the gas. This, in turn, makes it difficult to control the location and intensity of the discharge.

Ignition systems typically found in internal combustion engines include a low voltage switching circuit that drives a transformer, typically an autotransformer. Traditional ignition systems are powered by a 12 VDC supply (e.g., an automobile's battery) that drives a current through the primary winding of the transformer, storing energy in a magnetic field. After a fixed period of time, that current is interrupted resulting in a transient voltage pulse across a spark plug, which rises high enough to break down across the spark gap and create an arc. The interruption of current through the primary winding of the transformer produces a pulse. This pulse is generally understood using the following equation, which is derived from Ampere's Law and describes the current, voltage relationship of an inductor:

$$v = L \frac{d i}{d t}$$

Voltage across the inductor is v, the value of the inductance is L, the current through the inductor is i, and time is t. Interrupting the current through the primary winding with a switch produces a large di/dt (rate of change of current with respect to time), and therefore, a large voltage, v. The potential energy in the pulse is given by the formula that describes energy stored as a magnetic field in an inductor:

$$E = \frac{1}{2} {Li}^{2}$$

Energy is E, the inductance of the autotransformer's primary winding inductance is L, and the current through the primary winding before the current is interrupted is i. The rise time of the resulting pulse is determined by numerous factors, most notably: (1) the self-capacitance inherent to the secondary winding of the transformer, (2) the resistance inherent to the secondary winding of the transformer, (3) the resistance of the cable connecting the ignition coil to the spark plug, and (4) the opening time of the current interrupting switch. For autotransformer based ignition coils, these factors work together to produce pulse rise rates that are approximately 5×10⁸ V/s. Breakdown voltage for spark plugs operating at internal combustion engine (ICE) pressures typically ranges from 5 kV to 40 kV, resulting in pulse rise times between 10 μs and 80 μs.

Known magnetic pulse compression circuits are used to compress stored electrical energy into an electrical pulse. These circuits rely on the nonlinear relationship that exists between the applied magnetic field and the induced magnetic flux density in ferromagnetic and ferromagnetic materials. Previously disclosed circuits based on magnetic pulse compression transfer energy stored in the magnetic pulse compression circuit to a circuit that is devoid of energy before the stored energy is transferred. By pre-charging capacitors in the circuit, the voltage gain of the magnetic pulse compression circuitry can be enhanced.

Moreover, current state-of-the art ignition cables are designed to work with ignition systems that produce electrical discharges with durations of 10 μs to 100 μs. Microsecond long durations are typical of ignition systems used to ignite air-fuel mixtures. Because these pulses have microsecond-long rise times and durations, these cables consist of a single current carrying wire that is encased by an insulting material designed to isolate the pulse's high voltage. This single current carrying wire attaches to the spark plug (e.g., by a connector that uses friction to maintain the cable firmly connected to the spark plug). Return current passes through the engine block, through the chassis (or other conductive metal that connects the engine to the ignition coil), back to the ignition coil. The path taken by the return current is not well defined, but since the ignition coil and the engine are connected through a conducting path, the loop required for current flow is completed.

This arrangement works well for traditional ignition technology due to a temporal/spatial scaling relationship that determines how electric signals propagate. Slowly transitioning signals can traverse spatially large current paths before propagation effects related to the signal's speed become apparent. Since traditional ignition pulses are relatively slow (again, microseconds in duration and rise time), they can flow through the single current carrying conductor of the ignition cable and back through the chassis because the effective electrical delay of that path (which is in the order of tens of nanoseconds) is negligible compared to the pulse's microsecond-long rise time.

There remains, however, a need for improving the efficiency of combustion engines. For example, there remains a need to improve the efficiency of traditional ignition technology, and to overcome the limitations of conventional electric discharges and laser discharges. There further remains a need to generate an electric arc that generates plasma resulting in more efficient combustion by minimizing or avoiding the transition from plasma to spark break down.

The present disclosure addresses these and other needs.

### SUMMARY

Briefly and in general terms, the present disclosure is directed to systems and methods for improving pulsed power. In some embodiments, pulsed power is employed to improve fuel efficiency and power in engines by minimizing or avoiding the transition from plasma to spark break down.

In some embodiments, a transient plasma circuit is provided. The transient plasma circuit may be connected to a signal generating source (e.g., a standard ignition coil) that outputs at least one signal (e.g., an electrical pulse having a voltage and a current) that is destined to breakdown over a spark gap (e.g., the spark gap of a spark plug, a static spark gap, a rotary spark gap, and the like) at a first voltage. For example, the transient plasma circuit may be integrated into a spark plug or at any location between the signal generating source and the spark gap. The transient plasma circuit may be integrated into the signal generating source. Without the transient plasma circuit, the at least one output signal may (1) peak at a first voltage (e.g., the first breakdown voltage) at the time breakdown occurs over the spark gap, (2) have a rise time that substantially exceeds 500 ns, and (3) have a rise time and fall time that, when combined, substantially exceeds 500 ns. The transient plasma circuit may receive and use the at least one output signal received from the signal generating source to generate at least one fast rise, ultra-short, high voltage pulse. Generally, the at least one fast rise, ultra-short, high voltage pulse may (1) peak at a second voltage, which is greater than the first voltage, at the time breakdown occurs over the same spark gap, (2) have a rise time less than 500 ns, and (3) have a rise time and fall time that, when combined, is less than 500 ns. Even though the spark gap distance (i.e., the distance between the two electrodes across which the breakdown occurs) may not change, the transient plasma circuit enables the voltage to breakdown at a greater value than compared to the first voltage since the transient plasma circuit enables a higher impedance discharge compared to the lower impedance discharge that is generated without the transient plasma circuit. In other embodiments, the rise time of the pulse is less than 100 nanoseconds.

In other embodiments, an advanced, compact, and reliable electrical pulse generator is provided. The pulse generator generates and delivers fast rise, ultra-short, high-voltage pulses to a spark gap over a shielded, twisted pair cable. For example, the spark gap may be a standard spark plug or an electrically isolated spark plug. The standard spark plug may be connected to a common ground (e.g., engine block and chassis) whereas the electrically isolated spark plug may be a standard spark plug that is electrically isolated from the common ground in that it is connected to a floating ground.

In yet other embodiments, a transient plasma plug is provided. The transient plasma plug generates and delivers fast rise, ultra-short, high-voltage pulses to a spark gap. The transient plasma plug may include the transient plasma circuit.

As disclosed herein, the transient plasma circuit or pulse generator enables an engine to ignite an air-fuel mixture more efficiently (e.g., burn fuel more completely). This is accomplished by minimizing or avoiding the transition from plasma to spark break down. Less fuel is consequently required to achieve the same or greater power output. In this regard, the air-fuel mixture may be adjusted accordingly (e.g., decrease the amount of fuel). Even without adjusting the air-fuel mixture, the more efficient combustion that results from the high-voltage pulses yields better gas mileage (i.e., more power is output by the engine without adjusting the air-fuel mixture). Fast rise, ultra-short, high voltage electrical pulses are generated within a nanosecond time frame such that energy is utilized in a more efficient process to create energetic electrons (e.g., plasma, or more specifically, plasma streamers). Such energetic electrons collide with the air-fuel mixture in a volume (e.g., a piston chamber), thereby breaking down the mixture and making it easier to burn.

A system or method incorporating the fast-rise, ultra-short, high peak power pulses ignites fuel more quickly, more easily ignites complex fuels, ignites leaner mixtures, ignites faster moving mixtures and garners more power from the fuel. Again, this is accomplished by minimizing or avoiding the transition from plasma to spark break down. Consequently, there is an increase in engine efficiency (e.g., combustion efficiency such as a leaner burn capability), and a reduction in emissions and ignition delay (i.e., the time from the moment the pulse is generated to the moment combustion has begun); all while using the same amount of electrical energy as a traditional ignition source. In some embodiments, under certain conditions, as much as a 20% or more increase in engine efficiency results from using the transient plasma circuit or pulse generator. Also in some embodiments, as much as a 30% or more increase in pressure generated in a volume (e.g., piston chamber) during and/or after combustion results from using the transient plasma circuit or pulse generator. Increased power is achieved when air-fuel mixtures remain constant, thus, resulting in an increase of fuel efficiency when the air-fuel mixtures are burned.

As disclosed herein, in some embodiments, a transient plasma plug is provided for generating the fast rise, ultra-short, high energy pulses resulting in a rise time nanoseconds in duration as well as an overall duration (i.e., rise time and fall time) that is also nanoseconds in duration. Transient plasma plugs are configured to replace traditional (e.g., standard) spark plugs in an engine.

In still other embodiments, as disclosed herein, a nanosecond pulse generator and a nanosecond controlled ignition cable are provided to cooperate with traditional spark plugs to create fast rise, ultra-short, high energy pulses.

In addition, methods for enhancing the ignition of air-fuel mixtures are disclosed herein. The method includes generating a fast rising voltage pulse, creating plasma, and introducing the plasma with an air-fuel mixture to create reactive species thereby enhancing efficiency of combination chemistry.

Moreover, a system for enhancing the ignition of air-fuel mixtures is disclosed herein. The system includes a generator of a fast rising energy pulse, the pulse creating plasma, wherein combining the plasma with an air-fuel mixture results in the creation of a reaction species that enhances the efficiency of combustion chemistry of the engine.

In various embodiments, the method and system can further involve or include providing a transient plasma plug assembly that generates the fast rising voltage pulse which creates plasma. Alternatively or additionally, the method and system can further involve or include a compression line circuit that generates fast rising, ultra-high voltage pulses cooperating to create plasma streamers. In some embodiments, the compression line circuit is the pulse generator. In other embodiments, the compression line circuit may be built into the cable that connects the pulse source to the spark plug electrode.

The foregoing summary does not encompass the claimed subject matter in its entirety, nor are the embodiments intended to be limiting. Rather, the embodiments are provided as mere examples.

Other features of the disclosed embodiments will become apparent from the following detailed description, taken in conjunction with the accompanying drawings, which illustrate, by way of example, the principles of the disclosed embodiments.

### BRIEF DESCRIPTION OF THE DRAWINGS

FIG. 1A is a schematic representation, depicting one embodiment of a transient plasma plug that generates high peak power pulses.

FIG. 1B is a schematic representation, depicting another embodiment of a transient plasma plug that generates high peak power pulses.

FIG. 1C is a cross-sectional view, depicting one embodiment of a transient plasma plug.

FIG. 2 is a graphical representation, depicting a comparison of traditional spark plug and transient plasma plug performances according to one embodiment.

FIG. 3 is an enlarged graphical representation, depicting the performance of the transient plasma plug according to one embodiment.

FIG. 4 is a graphical representation, depicting how the relationship between pressure and time change for transient plasma ignition compared to traditional spark ignition.

FIG. 5 is a graphical representation, depicting how the relationship between pressure and crank angle change for transient plasma compared to traditional spark ignition.

FIG. 6 is a schematic representation, depicting a lumped element magnetic compression line circuit.

FIG. 7 is a schematic representation, depicting a 4-stage compression circuit model according to one embodiment.

FIG. 8 is a graphical representation, depicting waveforms produced by a 4-stage model circuit according to one embodiment.

FIG. 9 is a schematic representation, depicting one approach to a pulse generator and ignition cable arrangement according to one embodiment.

FIG. 10 is a schematic representation, depicting another approach to a pulse generator and ignition cable arrangement according to one embodiment.

FIG. 11 is a schematic representation, depicting another approach using a standard ignition coil in association with a transient plasma plug assembly and a standard spark plug.

FIG. 12A is a cross-sectional view, depicting an embodiment of a differential spark plug.

FIG. 12B is an enlarged end view, depicting an interface of the differential spark plug of FIG. 12A for connection to a cable assembly.

FIG. 12C is a cross-sectional view, depicting an embodiment of a differential ignition cable.

FIG. 12D is an enlarged end view, depicting structure of the cable of FIG. 12C for receiving an interface of a differential spark plug.

### DETAILED DESCRIPTION OF THE PREFERRED EMBODIMENTS

The present disclosure relates to igniting air-fuel mixtures, including but not limited to igniting air-fuel mixtures in internal combustion engines. In combustion engines, air-fuel mixtures are typically ignited by an electrical pulse with a duration of many microseconds, which initiates an electrical breakdown. For pulses with durations of approximately one microsecond and longer, this discharge ultimately becomes an arc, and the heat generated by the arc raises the temperature of the air-fuel mixture to its ignition temperature. Shorter, nanosecond duration pulses with sufficiently high-peak power can enhance the combustion process by applying electrical energy more directly to the air-fuel mixture by virtue of high-energy electrons. These high energy electrons, which are not found in discharges created by traditional ignition systems that produce longer pulses, collide with molecules in the air-fuel mixture and create reactive species that enhance combustion chemistry. This results from minimizing or avoiding the transition from plasma to spark break down. As disclosed herein, this can result in improved fuel efficiency and performance. To realize these benefits, it is necessary for the rate of rise of the voltage pulse that creates the discharge to be sufficiently fast. This fast rising pulse enables a formative phase of plasma, which may consist of plasma streamers. These streamers contain the high energy electrons which play a major role in realizing the benefits described herein.

Accordingly, disclosed herein is a system or method incorporating, fast rise, ultra-short, high energy pulses that (1) ignite fuel more quickly, (2) more readily (3) ignites complex fuels, (4) ignites leaner mixtures, ignites faster moving mixtures, and (5) that produces more power from the fuel. This approach, thus, produces (1) an increase in engine efficiency, (2) a reduction in emission and ignition delay and (3) a leaner burn compatibility, all while using the same amount of electrical energy as a traditional ignition. An increase of 20% efficiency or more can result, along with as much an increase of 30% increase in pressure using less energy. This increased power is achieved even when the air-fuel mixture remains constant. Thus, there is an increase in fuel efficiency as the air-fuel mixtures are burned.

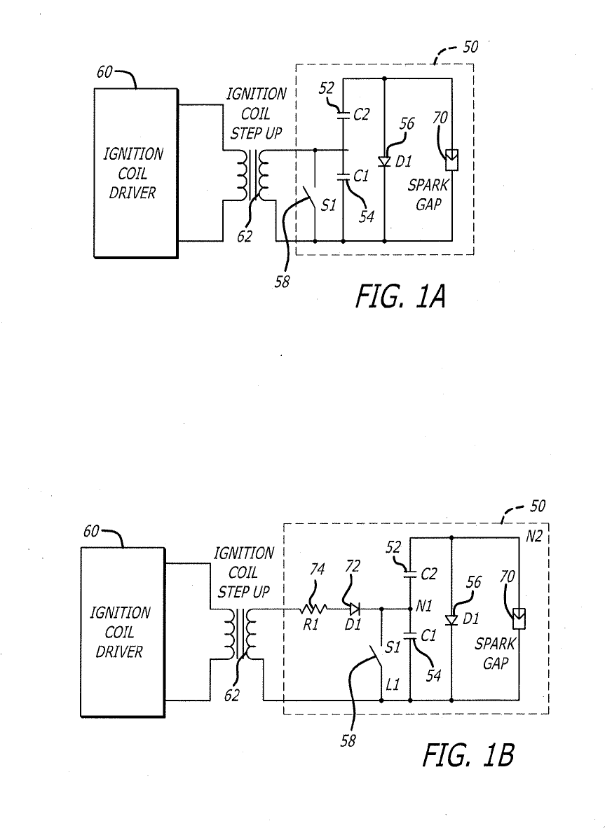

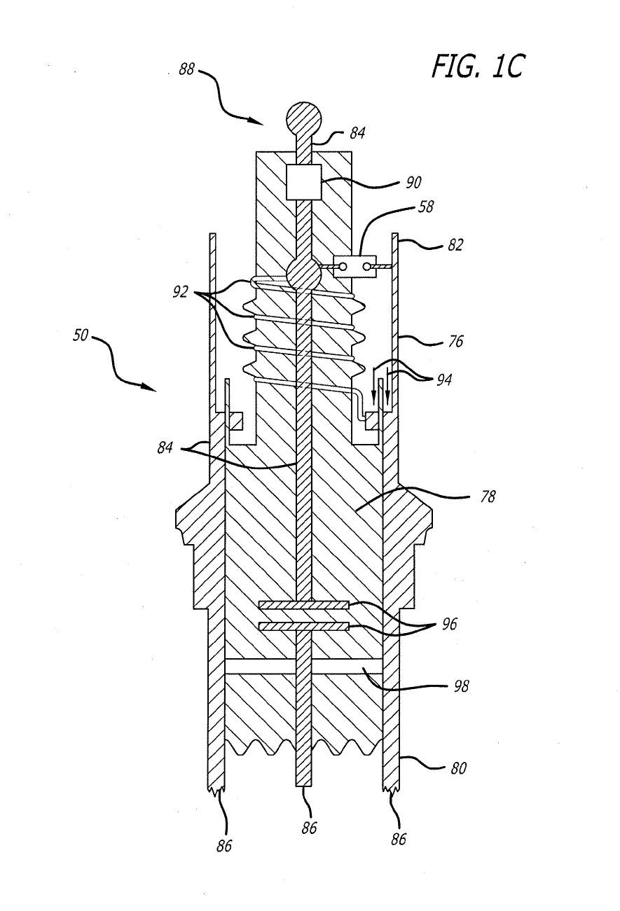

Referring now to the Figures, wherein like numerals denote like or similar structures, and, more particularly to FIG. 1, one embodiment of a transient plasma plug assembly 50 is depicted. As shown in FIG. 1, one embodiment of the transient plasma circuitry is integrated with a spark plug (i.e., in the circuitry is located within the spark plug itself, as opposed to located elsewhere within the system). The transient plasma plug assembly 50 interfaces with existing technology that produces typical, microsecond long ignition pulses. Therefore, the transient plasma plug assembly 50 does not require replacing the existing ignition system except for the spark plug. The transient plasma plug assembly 50 receives the generated output signal, that is, the stepped-up voltage from the ignition coil driver 60 and the transformer 62 (e.g., from an existing automotive ignition system). The stepped-up output signal is a relatively long high voltage pulse having a rise time to a breakdown voltage substantially in excess of 500 nanoseconds like the typical pulse created by an automotive ignition coil. The transient plasma plug assembly 50 receives and reshapes the stepped-up output signal to a fast rise, ultra-short, high-voltage pulse having a rise time to a breakdown voltage duration, less than 500 nanoseconds and, in some embodiments, less than 100 nanoseconds. This produces a plasma discharge (e.g., containing plasma streamers) that is rich with high-energy electrons.

In one embodiment, two capacitors 52 and 54, a diode 56, and a switch 58 (e.g., a spark gap that is distinct from the spark gap of the spark plug itself) are integrated into the transient plasma plug assembly 50. FIG. 1A illustrates one embodiment of the arrangement of these components. The output of the standard ignition coil 60 is connected across the switch 58, S₁. When the ignition coil 60 is triggered, energy is transferred across the step-up coil 62 into C-₂52 and C₁ 54. During this period, S₁ 58 is open and the current transferred across the step-up coil 62 is split between C₁ 54 and C₂ 52 Current flows through C₁ 54 to ground and through C₂ 52 and diode D₁ 56 (or any suitable component for maintaining a path of least resistance such as a resistor) to ground, so the two capacitors appear to be in parallel during this phase, and the voltage across the spark plug's gap 70, which is in parallel with D₁ 56, is nearly zero. After the voltage across C₁ 54 and C₂ 52 reaches a predetermined voltage, switch S₁ 58 closes. At this point, the energy stored in C₁ 54 flows through S₁ 58, resonating with parasitic inductance in the connection. As a result of this resonance, the voltage across C₁ 54 becomes approximately the inverse of its initial value. When this happens, the voltage across C₂ 52, which has not changed, adds in series with the inverted voltage of C₁ 54. This voltage appears across the spark plug's gap 70, leading to a discharge that is characterized by the presence of transient plasma streamers.

The predetermined voltage referred to above may depend on the switch S₁ 58. For example, in embodiments where the switch S₁ 58 is a spark gap, the predetermined voltage may be the breakdown voltage across the spark gap. Alternatively, the predetermined voltage may be the voltage across capacitor C₁ 54 when it reaches the breakdown voltage of switch S₁ 58. In some embodiments, the predetermined voltage may be 20 kV. In other embodiments, the predetermined voltage may be less than or greater than 20 kV.

The rise time of this configuration is determined by the resonant period of C₁ 54 with the parasitic inductance in the system. A faster resonant period means a faster rise time. In another embodiment (not shown), an inductor, either air-core or magnetic-core, may be inserted between the top terminal of S₁ 58 and the top terminal of C₁ 54. This inductor may be used to adjust the resonant period, as well as, the quality factor of the resonance. Quality factor is the ratio of energy stored to energy dissipated per cycle and significantly influences the maximum output voltage that can be achieved with this type of configuration.

In another embodiment, as shown in FIG. 1B, additional circuitry can be provided to ensure current flows in a desired direction. A second diode D₂ 72 can be provided between the ignition coil step up 62 and switch S₁ 58. A resistor R₁ 74 can also be located to aid in this control of current flow. It is to be recognized that the first diode D₁ 56 can be replaced with other circuitry as long as such substitute circuitry maintains the desired function of generating the pulse. Accordingly, the first diode D₁ 56 can be replaced with a magnetic coil that is pre-saturated, a linear coil, or a resistor, as long as a path of least resistance is maintained. Likewise, D₂ can alternatively be a resistor, inductor or switch, for example, so long as current flows in one direction and the charging of the capacitors C₁ 54 and C₂ 52 occurs.

One embodiment of a transient plasma plug assembly 50 is shown in FIG. 1C, where circuit components are embedded in the assembly itself. This approach presents a compact structure which saves space and provides the structure to generate a fast rise, ultra short, high voltage pulse. This particular depicted assembly 50 includes an elongate body defined in part by an outer conductor casing 76. An insulator 78 is contained by the casing 76 and extends substantially a length of the casing, beginning within a first end 80 of the casing and extending beyond a second end 82 of the casing. The conductor casing 76 can be made from a high nickel steel or other suitable materials, and the insulator, for example, can be formed from Al₂O₃ or other suitable materials. Another elongate conductor 84 is configured within the insulator 78 and arranged generally parallel to walls defining the outer conductor casing 76. At the first (bottom) end 80 of the assembly 50, the conductor casing 76 and elongate conductor 84 form structure defining electrode tips 86, which can be made from tungsten or other suitable materials. At a top end 88 of the assembly 50, the elongate conductor 84 projects beyond the insulator 78 to present structure configured to receive an ignition cable (not shown).

Various other components of the contemplated transient plasma plug assembly 50 described herein are also shown in FIG. 1C. A resistive element 90 such as one or more of a resistor and/or a diode (See also elements R₁, D₂ of FIG. 1B) is shown configured at the top end 88 of the assembly 50. The resistive element 90 is configured about the elongate conductive element 84 and within the insulator 78. Below the resistor element 90, the spark gap switch S₁ 58 is positioned to form a connecting structure between the elongate conductor 84 and the outer conductor casing 76. An inductive coil 92 is further provided (See also for example, L₁ FIG. 1B), the coil 92 being wrapped about the insulator 78, and having a first end connected to the elongate conductor 84 and a second end attached to the outer conductor casing 76. A cylindrical capacitor 94 is additionally provided to connect the coil 92 to ground. Moreover, configured between the top end 88 of the transient plasma plug assembly 50 and the electrode tips 86 are a series capacitor (See also C₁ 52, C₂ 54 of FIGS. 1A-B) and a resistive disk 98 (See also component D1 56 of FIGS. 1A-B as alternative elements). Other contemplated embodiments can include an enclosure for containing the various electrical components that is located separately from the plug itself. It is to be recognized that various other components can be incorporated, and substitution and additions can be made to the transient plasma plug assembly 50 shown in FIG. 1C which are consistent with this disclosure.

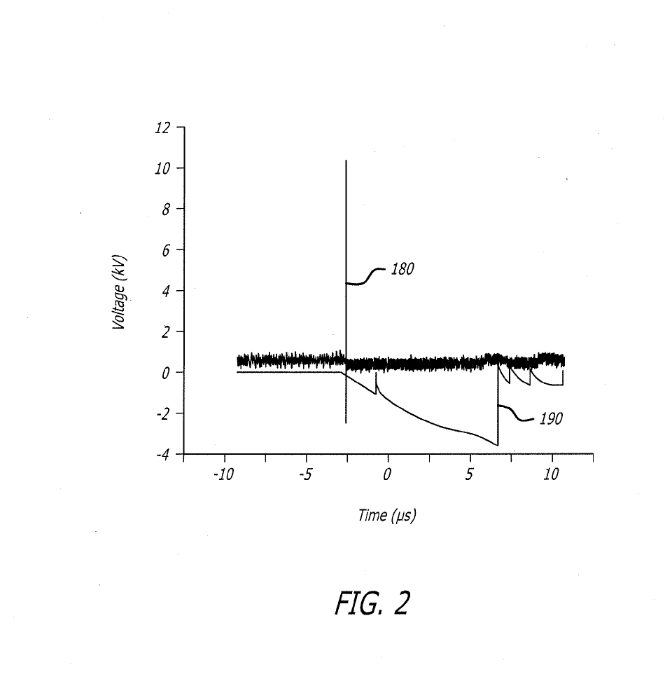

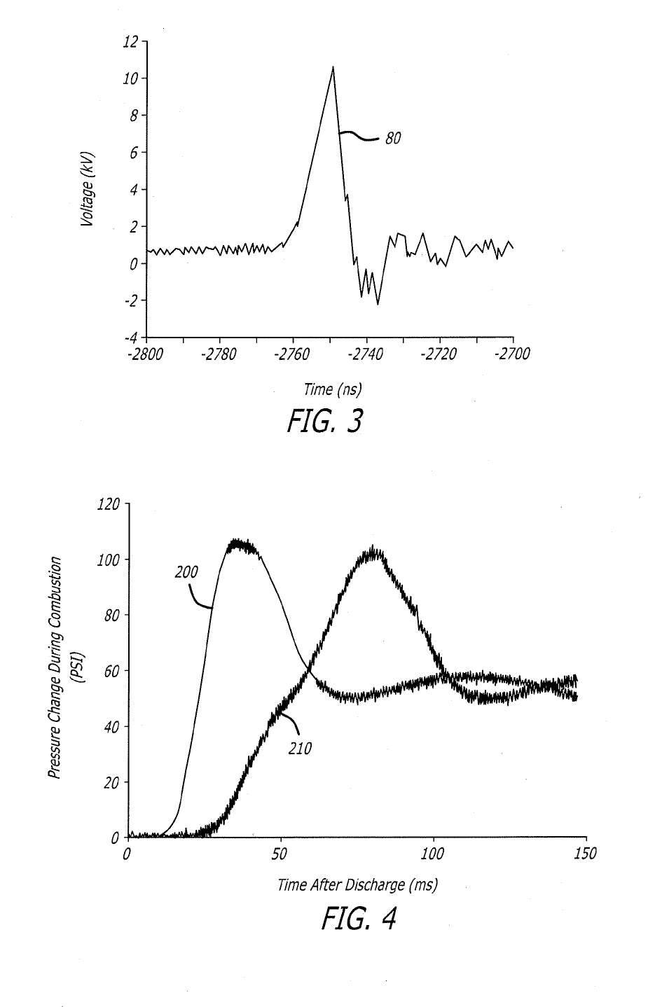

The outputs of the embodiments depicted in FIGS. 1A-B are shown in FIGS. 2 and 3, which show a comparison between the nanosecond pulses 180 created by the transient plasma circuit 50 shown in FIGS. 1A-B and the microsecond pulse 190 created by the ignition coil 60. To obtain this result, a traditional 12 VDC powered ignition coil 60 can be connected across switch S₁ 58 of FIG. 1. The curves in FIGS. 2 and 3 illustrate that the transient plasma circuit 50 decreases pulse rise time and duration by a factor of approximately 1000, from 10 μs to 10 ns. In one particular embodiment, the transient plasma plug 50 can include the following components: C₁=C₂=100 pF; a 30 kV, 1.5 Amp automotive rectifier for D₁, and a spark gap for S₁. 58. The spark gap used for S₁ is designed to breakdown, forming a highly conductive arc, once the voltage across C₁ 54 reaches a predetermined value. In this approach, the spark gap 58 switch is self-triggered when the voltage across C₁ 54 in FIG. 1C reaches the breakdown voltage of the spark gap 58. As discussed above, the predetermined voltage may be 20 kV. In other embodiments, the predetermined voltage may be less than or greater than 20 kV.

In addition to traditional ignition systems that are powered by 12 VDC, there are capacitive discharge systems that store energy in a capacitor at higher voltages (e.g., between 300 and 400 VDC). These systems often make use of a configuration in which each spark plug attaches to its own transformer, which receives energy from the capacitor. Higher primary side voltage may reduce the number of turns required on the secondary side of the transformer, which reduces the cost of the unit and increases the overall efficiency. The transient plasma circuit described herein may interface with traditional 12 VDC ignition systems, these higher voltage capacitive discharge ignition systems, or other traditional ignition systems. The transient plasma circuit disclosed herein is driven by existing ignition systems to reduce energy pulse rise time (typically from microseconds to nanoseconds) and to increase pulse amplitude of the amplitude created by the existing ignition system (typical increases from 1%-1000% or more).

Motivation for reducing pulse duration (i.e., rise time) and increasing pulse amplitude is that voltage pulses with fast rates of rise and high amplitudes enhance the combustion process in a number of ways. Such an approach can result in an increase in peak engine power, particularly for lean burn conditions. This indicates that fast rising pulses can be used to reduce fuel consumption without compromising the engine's performance. Further, a transient plasma discharge with a reduced electric field, E/n, on the order of hundreds of Townsend (Td) results in the production of active particles in streamer channels through electron impact dissociation, excitation, and ionization of atoms and molecules. These active species significantly impact chain branching reactions, reducing ignition delay times and allowing for lean burn combustion (equivalence ratio, φ<0.7). Due to the limitations of existing ignition systems that prevent fast rise times, transient plasma streamers are never formed. Rather, an arc is formed after the voltage reaches a critical value, and thermal energy is transferred to the fuel-air mixture, heating it until it ignites. Increased efficiency for lean burn combustion is a way to reduce fuel consumption, thus increasing engine efficiency.

As stated above, employing transient plasma streamers can lead to improved performance. With reference to FIG. 4, using a transient plasma streamer approach leads to improvement in fuel efficiency and a reduction in emissions by 20% or more in some engines. Again, this result is accomplished using either the transient plasma plug arrangement alone, a pulse generator and ignition cable arrangement (described in more detail herein), or other disclosed arrangements (e.g., integrating the transient plasma circuit elsewhere in the system rather than at the spark plug itself). As illustrated, when using a transient plasma streamer approach (see curve 200 in FIG. 4), pressure produced during combustion rises quickly as compared with traditional spark plugs (See curve 210 in FIG. 4). Thus, the fuel ignites more quickly and more power is obtained from the fuel. Also, complex fuels are ignited more easily and leaner fuel mixtures and/or as can faster moving mixtures can likewise be ignited.

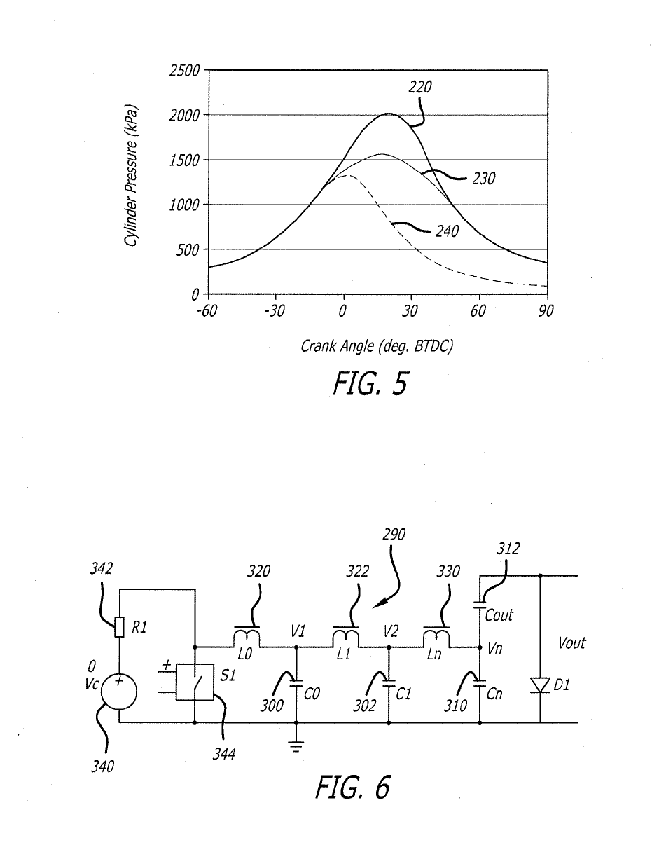

Moreover, greater than a 30% increase in cylinder pressure can be achieved using a transient plasma streamer approach. As shown in FIG. 5, the cylinder pressure versus crank angle in a transient plasma streamer system, represented by curve 220, reaches a significantly higher value than in traditional spark plus arrangements (curve 230) and as compared with pressure where there is no combustion (curve 240). This results in increased power when air-fuel mixtures remain constant, as well as, increased fuel efficiency when the air-fuel mixture is leaned.

The concept of providing a transient plasma plug assembly to generate ultra-short, high voltage pulses with sufficiently fast rise times to produce transient plasma streamers is not limited to the embodiment shown in FIG. 1. Other embodiments may include the following:

1. Switch S₁ is a triggered solid state switch, such as a MOSFET, IGBT, BJT, thyristor, or other solid state switch.

2. Switch S₁ is placed across C₂ instead of across C₁. Functionality is the same as described previously, except energy resonates in C₂ instead of C₁.

3. The ignition coil step-up transformer is redesigned so that the magnetic core of the transformer saturates once the voltage across C₁ and C₂ reaches a specified value. In this embodiment, switch S₁ is part of the ignition coil step-up transformer. Once the transformer saturates, the secondary inductance falls dramatically, acting as a switch.

4. C₁ and C₂ are replaced by a single capacitor, C. D₁ is removed. Switch S₁ is placed between the top terminal of C and the top terminal of the spark plug's gap. Switch S₁ closes once the voltage across C reaches a specified value.

In yet another approach, rather than replacing a traditional spark plug or a differential (electrically isolated) spark plug with a transient plasma plug, a pulse generator including a magnetic compression based stepped impedance transmission line circuit can be employed. Discharging an initially charged lumped element transmission line with saturable inductor switches in each cell can result in complete energy transfer, but only if the cell capacitances are in a certain fixed sequence. Charge conservation is used to derive this sequence. Thus, a discrete analog of traditional stepped impedance transmission line transformers is contemplated. The circuit also includes resonant voltage doubler features.

In a standard magnetic pulse compression circuit, voltage V₁ starts to rise from zero to peak in a half period of the waveform given by

V₁(t)=V₀[1−cos(ωt)] (1)

At the instant of the voltage peak, V₁(t)=2 V₀, the inductor L₁ saturates and switches from L₁ to a much smaller L_{IS} and the energy in C₁ gets resonantly transferred to C₂. Due to the small saturated inductance, L_{IS}<<L₁, the rate of rise of the voltage V₂ is greater than the rate of rise of the input voltage V₁. It has been shown that full energy transfer only happens if C₁ and C₂ are equal. As shown in FIG. 2, the energy fraction is transferred as a function of capacitance ratio.

The classical analysis described above treats only the case of C₂ initially having zero voltage, i.e. V₂(0)=V_{c}=0. Therefore, it is instructive to consider the general case of arbitrary pre-charge voltage, V_{c}.

When neglecting losses, and requiring full energy transfer, the total energy stored in C₂ at the end of the cycle is then the sum of the energy initially stored in C₁ and C₂:

$$\frac{1}{2} {C}_{1} {V}_{1}^{2} + \frac{1}{2} {C}_{2} {V}_{C}^{2 } = \frac{1}{2} {C}_{2} {V}_{2}^{2} \qquad ( 2 )$$

Also, requiring charge conservation:

C₁V₁+C₂V_{C}=C₂V₂ (3)

And eliminating V₂ gives the relation between the normalized charge voltage, v=V_{c}/V₁, and the capacitance ratio, c=C₁/C₂:

$$v = \frac{1 - c}{2} \qquad ( 4 )$$

Thus, the normalized output voltage, vₒᵤₜ=V₂/V₁, is then:

vₒᵤₜ=c+v (5)

Interestingly, the precharge must be negative if C₂ is smaller than C, and then voltage multiplication will occur with complete energy transfer. Notably, these characteristics are independent of the inductances L₁ and Lₛ.

One embodiment of such a pre-charged compression circuit 290 is shown in FIG. 6. Consider a charged lumped element transmission line with capacitors, C₀ 300, C₁ 302 . . . Cₙ 310, Cₒᵤₜ 312, and saturable inductors, L₀ 320, L₁ 322 . . . Lₙ 330, separating each cell from its neighbors, as is shown in FIG. 6. This line is charged to voltage V_{C} 340 through charging resistor R₁ 342 and discharged by switch S₁ 344 (although other charging and discharging arrangements can also be used, i.e., a saturable transformer for both pulse charging and discharging the line).

At time t=0, all capacitors are charged to +V_{C} voltage, and the switch S₁ 344 is closed. All inductors except L₀ 320 are in the high impedance state and all cells, except the first cell, are isolated from each other. Capacitor C₀ 300 will then discharge through L₀ 320, and in the absence of dissipation, reverse charges to voltage −V_{C}.

Initial voltage on C₀ 100 is −V_{C} while all other capacitors are charged to +V_{C}. At this point, without loss of generality, it is possible to recast equations 2-5 above in terms of the generic cell, containing Cᵢ and Lᵢ, to generate

$$\begin{matrix}\frac{1}{2} {C}_{i - 1} {V}_{i - 1}^{2} + \frac{1}{2} {C}_{i} {V}_{C}^{2} = \frac{1}{2} {C}_{i} {V}_{i}^{2} & ( 6 ) \\ {C}_{i - 1} {V}_{i - 1} + {C}_{i} {V}_{C} = {C}_{i} {V}_{i} & ( 7 )\end{matrix}$$

Yielding the successive voltages and capacitance ratios

$$\begin{matrix}{V}_{i - 1} - {V}_{C} = {V}_{i} & ( 8 ) \\ {C}_{i} = 1 - \frac{2 {V}_{C}}{{V}_{i - 1}} & ( 9 )\end{matrix}$$

Consequently, it is clear that every stage adds the voltage −V_{C} to the previous stage voltage, so the output voltage is the sum of the charge voltage on the output capacitor, −V_{C} and that the voltage at the last stage, Vₙ=−n V_{C}. Hence, the output voltage is V_{OUT}=−(n+1) V_{C}. The capacitance at stage i is the sum of the previous two capacitors, looking back from the end, C₁=Cᵢ₊₁+Cᵢ₊₂. The output capacitor is part of this sequence as well, since in order to fully discharge the line the charge on the last capacitor must equal the charge on the output capacitor, Cₙ|Vₙ|=C_{OUT}|V_{C}|. This, therefore, produces C_{OUT}=Cₙ(|Vₙ/V_{C}|)=n Cₙ.

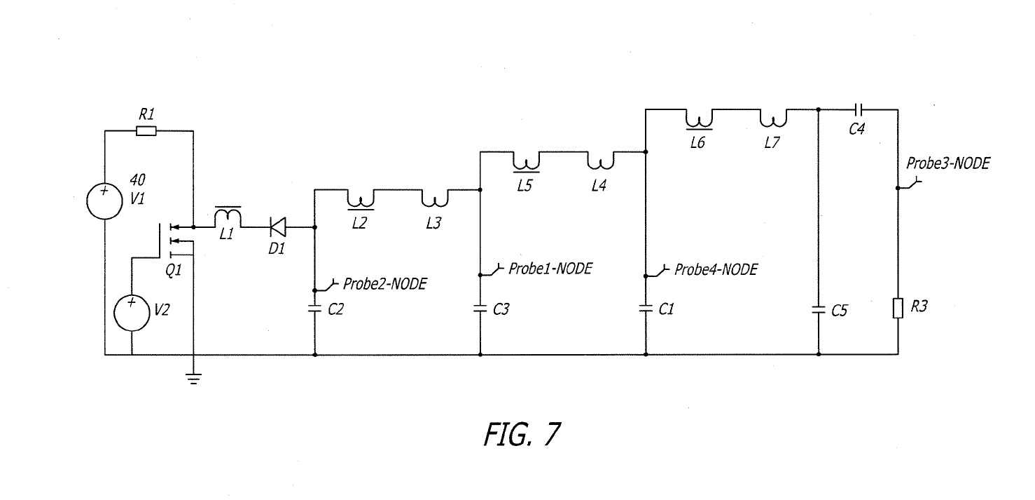

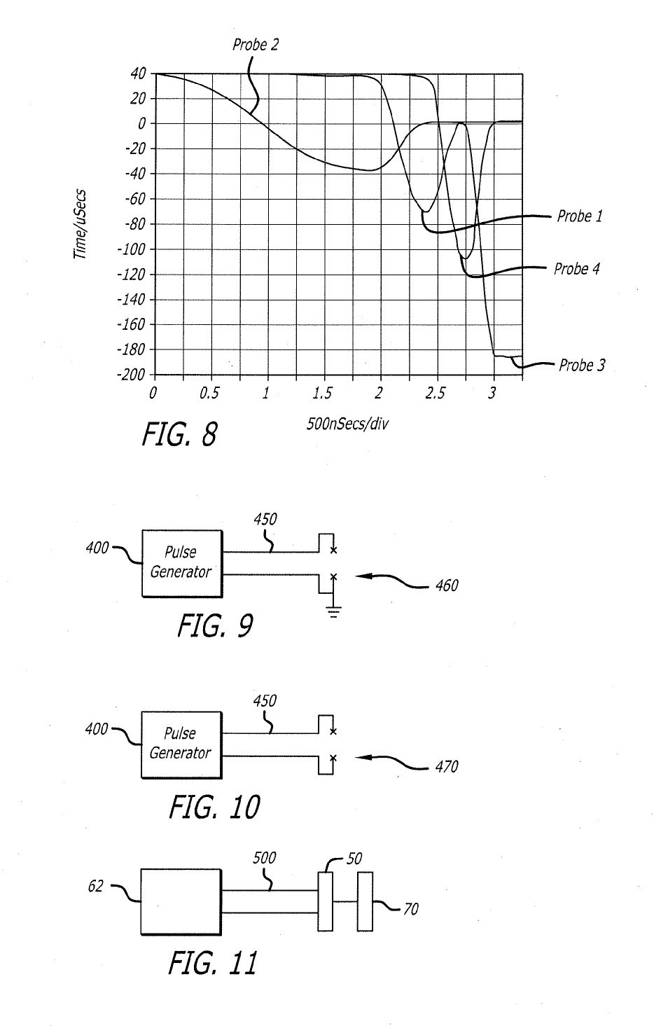

One example of a practical four stage compression circuit is shown in FIG. 7 and the resulting SPICE output of the stage voltages are shown in FIG. 8. As shown, the stage voltages all return approximately to zero, leaving no energy within the circuit, except at the output.

Another factor to consider is the effect of current leakage through the saturable inductors. In a standard compression stage, the leakage current generates an equivalent precharge with the same polarity as the incoming voltage wave, and this can be compensated for by increasing the output side cell capacitance (with capacitance ratio less than 1). This leads to loss of output voltage. In the case of the new stepped line, the leakage current also reduces the voltage multiplication factor by requiring a modification to the capacitance ratios, but the inherent voltage multiplication property still operates, to produce both leading edge compression and voltage transformation.

With respect to cell inductor volume, estimating the volume of the core, Volᵢ, of the saturable inductor in a compression cell leads to the formula

$${Vol}_{i} = \frac{2 {π}^{2} {E}_{i - 1} {μ}_{s} {μ}_{o} {R}_{i}^{2}}{g Δ {B}_{S}^{2} ( 1 + \frac{{C}_{i - 1}}{{C}_{i}} )} \qquad ( 10 )$$

Here Eᵢ₋₁ is the energy in the input side capacitor, Rᵢ is the cell compression ratio, ΔB_{S} is the saturation magnetic field swing, μₛ is the relative magnetic permeability of the saturated core (˜2 in practice) and g is the packing fraction of the core volume filled with magnetic material. This corresponds to the standard equation, modified by the term in the denominator containing the capacitance ratio. For the above case of stepped impedance precharged line, this leads to significant reduction (approximately a factor of 2 at most in the first stage) in required core volume as compared to the standard non-precharged case.

The number of turns needed can be calculated by the standard formula:

$${N}_{i} = \frac{{V}_{i - 1} π \sqrt{{L}_{Si - 1} {C}_{i - 1}}}{g Δ {B}_{S} {A}_{core}}$$

Here the saturated inductance of the previous stage, L_{Si-1} and the core area, A_{core}, are introduced.

As noted above, the effects of nanosecond pulses on combustion of air-fuel mixtures shows that short pulses, typically those less than 500 ns (and in some embodiments less than 100 ns), favorably alter the combustion chemistry in ways that should lead to increased efficiency and reduced emissions in practical applications. In other embodiments, the duration of the fast rise, ultra-short pulses will depend on such factors as circuit configuration, temperature and pressure such that the duration is less than that required to form an arc along the spark gap. Thus, pulse durations less than 500 ns and durations greater than 500 ns may be used without departing from the disclosed technology.

Still further, practical applications, require a means of reliably transmitting the pulse from the pulsed power source described above to the spark plug. Existing ignition cable technology is inadequate. Existing ignition cables are designed to work with microsecond long pulses created by existing ignition systems and typically consist of an electrically insulated current carrying wire that is resistive. This type of cable works for traditional ignition systems because the length of the cable is short compared to the duration of the microsecond ignition pulse. This is not the case for nanosecond pulses, for which the ignition cables length makes up a significant fraction of the nanosecond pulse's duration. The fact that the cable appears to be electrically long to the nanosecond pulse means that the cable has the ability to seriously distort the pulse. Therefore, preventing the pulse from initiating a discharge at the spark plug. Thus, an ignition cable that differs from existing ignition cable technology is required to prevent the distortion of nanosecond energy pulses.

If pulses with nanosecond rise time and duration (i.e., rise time and fall time) are used to ignite the air-fuel mixture, pulse transmission becomes significantly more complex. The effects of having a current loop with a delay that is a significant fraction of the pulse's duration can be modeled effectively by distributed circuit parameters, such as inductance and capacitance. If a pulse propagates through poorly controlled inductive paths that are loaded by shunt capacitance, the pulse becomes significantly distorted (increased duration, reduced amplitude) and is, therefore, unable to ignite the air-fuel mixture.

In one arrangement (See FIG. 9), a pulse generator circuit 400 such as that described above is connected to an ignition cable 450 having the ability to transmit high voltage, fast rise pulses. The ignition cable 450 is, in turn, placed in electronic communication with a standard spark plug 460. In another arrangement (FIG. 10), the pulse generator circuit 400 and ignition cable 450 can be employed to provide high voltage, fast rise pulses to a differential spark plug 470, one that is electrically isolated. As will be developed below, in the second approach, the ignition cable 450 can embody an additional connector that acts as a shield and also connects to a system ground. In yet another arrangement, a transient plasma circuit is connected between a standard ignition coil 480 and the ignition cable 450. The ignition cable 450 is, in turn, placed in electronic communication with a standard spark plug.

In FIG. 11, there is shown yet another embodiment. A standard ignition coil 62 is connected to a standard ignition cable 500. This cable 500 is in electrical communication with a transient plasma plug assembly 50 having the ability to covert the electrical signal from the ignition coil 62 to a fast rise, high voltage pulse. This pulse is then electrically communicated to a standard, non-resistive spark plug 70. In some embodiments, the pulse may be electrically communicated to the standard, non-resistive spark plug 70 by attaching the transient plasma plug assembly 50 directly to the non-resistive spark plug 70 in a way similar to how coil-on-plug ignition systems attach directly to the spark plug. This embodiment may be used when there is a need to maintain the use of standard spark plugs in the engine and to maintain lower costs than those associated with manufacturing a transient plasma plug 50.

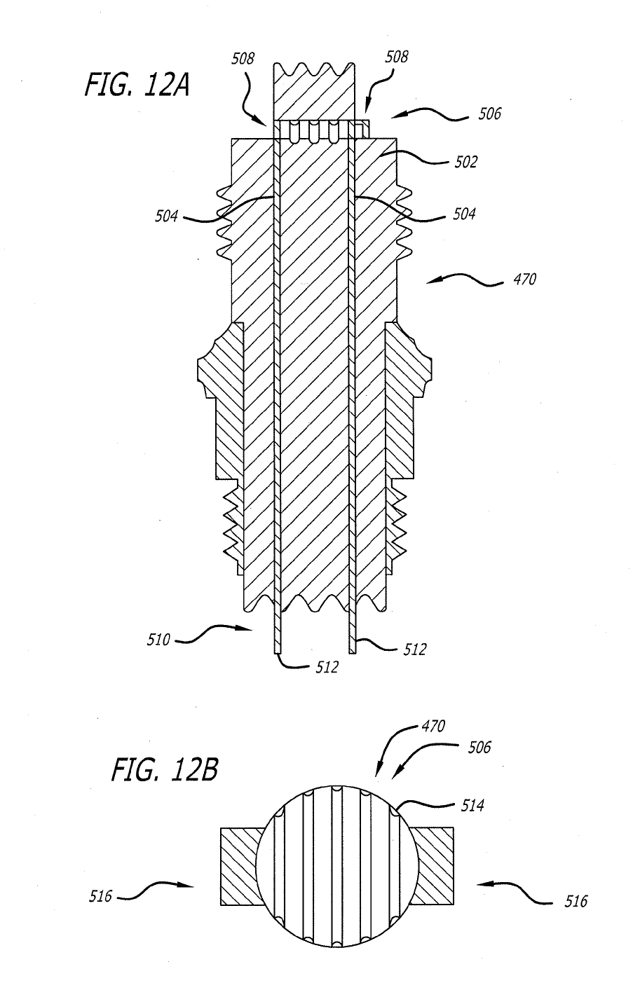

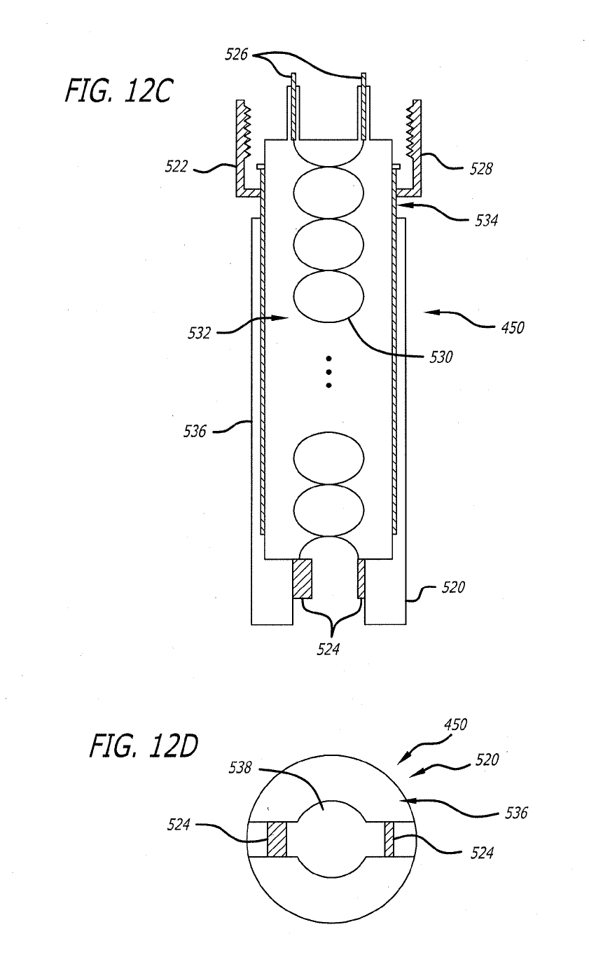

Continuing, with reference to FIGS. 12A-B, the presently described ignition cable addresses these issues, making it possible to transmit high voltage, fast pulses from the pulsed power source to the igniter or electrode system.

In one embodiment, the differential spark plug assembly 470 has a generally elongate body defined in part by an elongate insulator 502, which as described above, can be made from Al₂O₃ or any other suitable material. Extending beyond a length of the insulator 502 are a pair of elongate conductors 504. The conductors 504 can, as before, be made from high nickel steel or other suitable materials. At a top end 506 of the plug assembly 470, first end portions of the conductors 504 form connection terminals 508. A bottom end 510 of the conductors can include tungsten (or other suitable materials) tips 512. Additionally, configured at the top end 506 is a ribbed insulator cap 514 attached to the first end portion of the conductors 504. Positive and negative terminals 516 are further provided at the top end 506, and which are presented for connection to a differential cable assembly (See FIGS. 12C-D).

The differential cable assembly 450 depicted in FIGS. 12C-D includes an elongated body including a first end 520 for connecting to a differential spark plug 450, and a second end 522 configured to be connected to a pulse generator (not shown). The first end 520 includes positive and negative terminals 524 for connecting to cooperative structure 516 presented by the differential plug 470. The second end 524 further includes positive and negative terminals 526 for connecting to the pulse generator. The second end 524 also includes a threaded connector 528 configured to be connected to system ground or common (not shown).

Extending from the positive and negative terminals 526 for connecting to a pulse generator, to the positive and negative terminals for connecting to the differential plug 470, is a twisted pair of conducting wires 530 housed in an insulator 532. Cable insulator material 532 (e.g., HDPE or other suitable material) contains the conductor wires 530. Configured about the insulator material 532 is a conductive jacket 534 which can be formed of a copper braid or other suitable material. An outer insulator 536 is further provided about the conductive jacket 534 to define a significant portion of an outer surface of the cable assembly 450. With specific reference to FIG. 12D, it can be appreciated that the first end 520 of the cable assembly includes a central bore 538 that is sized and shaped to receive the ribbed insulator 514 of the differential spark plug assembly 470, so that the positive and negative terminals of the two structures can be placed in contact. Again, here, it is to be recognized that various components can be added to or substituted from the presented cable assembly for a particular desired purpose.

In one approach, there is shown an ignition cable that is able to transmit nanosecond, high voltage electromagnetic pulses from a power source to a spark plug without distorting the electromagnetic pulse. The cable's ability to transmit fast rise pulses over electrical lengths significantly longer than the pulse's duration is a crucial enabling feature of the ignition cable described in this document. Most practical systems have an appreciably distance (e.g., 1 meter or more) between the igniter and the pulsed power source that creates the electromagnetic pulse used to ignite the air-fuel mixture. The propagation delay time of many practical cables is approximately 5 ns/meter, which is a significant fraction of the duration of a pulse that lasts for one to tens of nanoseconds. The disclosed ignition cables enables the nanosecond, high voltage pulse to travel distances longer than the pulse duration (meters of length, significant nanoseconds of time), which ensures that the pulse maintains its appropriate amplitude and duration when it arrives at the igniter/electrode.

Additionally, the controlled current carrying paths provided by the ignition cable arrangement, combined with the ability to electrically shield the current carrying paths, reduces the electromagnetic interference that is frequently associated with fast rising, high voltage signals.

In one embodiment of an ignition cable, there are two current carrying conductors arranged in a twisted pair configuration, where one conductor is isolated from the other with an electrical insulator. The effective inductance per unit length of the conductors (determined by their conductivity, individual geometry) combined with the effective capacitance per unit length (determined by the electrical insulator's effective permittivity, and the geometry of the conductors with respect to one another), fix the ratio of the electric field to the magnetic field, thus controlling the electromagnetic ignition pulse as it traverses the ignition cable. The effective inductance per unit length and the effective capacitance per unit length also determine the ignition cable's propagation delay, which is approximately 25-200% of ignition pulse's duration. These current carrying conductors will be surrounded by a third conductor that is electrically connected to the common or ground potential of the system, which is usually the potential of the metal chassis that holds the engine and auxiliary systems in place.

In one embodiment, the ignition cable is balanced, meaning that the ignition pulse's voltage is applied across the ignition cable's two current carrying conductors, which are both electrically insulated from a third conductor that is electrically connected to the system's common potential.

Accordingly, in one approach, the ignition cable includes conductors that carry the forward and return current are arranged to shape the electric and magnetic fields of the ignition pulse such that the ratio of the peak electric field and peak magnetic field are fixed over the length of the cable. This ratio is known, predictable, and adjustable within an upper and lower bound by changing cable materials and cable geometry. Further, the ignition cable's propagation delay, which describes the amount of time it takes a signal to travel from the cable's input to the cable's output, is also well known, predictably determined by the cable's material properties and geometry, and can be adjusted in a controlled manner within an upper and lower bound by changing cable materials and cable geometry. Thus, in one embodiment, the transient plasma pulse has a duration of 10 ns, the differential cable has a propagation velocity of 2 ns/m, and a length of 2 meters, the propagation delay of the cable is 40% of the transient plasma pulse duration. The ratio of cable propagation delay and pulse duration may take on other values depending on cable length, cable geometry, cable materials, and transient plasma pulse duration.

Moreover, the ignition cable can include at least two current carrying conductors, but may contain more conductors, current carrying or otherwise. For example, as stated above, a third conductor can be incorporated into the assembly for shielding a twisted pair and connector to a system ground where a differential (electrically isolated) spark plug is utilized. These conductors are physically isolated from each other by insulating material, which is chosen to provide electrical isolation and also to fix the effective capacitance between the current carrying wires. Additionally, the ignition cable may be either balanced or single ended. If single ended, one of the two current carrying conductors is electrically connected to both the return current point of the ignition pulse generator and the spark plug or electrode. If balanced, the current carrying conductors may be electrically isolated from the engine block and/or chassis and also enclosed by a third conductor that is electrically connected to the chassis, engine block, or any other reference point.

The following describes contemplated materials and assembly for achieving the desired performance of the cable:

1. The two current carrying conductors includes stranded copper wire, each 18 AWG (having diameter of 1.024 mm).

2. The two current carrying conductors are arranged as a helical twisted pair, with a constant spacing of 10 mm between each conductor, resulting in an inductance per unit length of 12 nH/cm.

3. The current carrying conductors are centered in and enclosed by a cylinder of PTFE (Teflon). This cylinder has an outer diameter of 2 cm. This arrangement results in a capacitance per unit length of 195 fF/cm.

4. The PTFE is shrouded by a copper braid that is at the same electric potential as the system's common potential. For most engines, this is the potential of the metal chassis that holds the engine, ignition pulse source, and auxiliary subsystems in place.

5. If the ignition electrode assembly (at the output side of the ignition cable) features an anode and cathode that are electrically isolated from the system's common potential, both current carrying conductors of the ignition cable are also electrically isolated from the system's common potential.

6. If the ignition electrode assembly (at the output side of the ignition cable) is such that either the anode or cathode is electrically connected to the system's common potential, then the copper braid that enshrouds the PTFE dielectric may be electrically connected at any point to whichever current carrying conductor is at common potential.

7. The combination of the ignition cable's inductance and capacitance results in an effective electromagnetic impedance of 250Ω and a propagation delay of 50 ps/cm.

8. The length of the cable is such that the resulting propagation delay is at least 10% of the ignition pulse's duration at half of the pulse's amplitude. This implies a minimum length of 0.2 m for a 10 ns ignition pulse, a minimum length of 1 m for a 50 ns pulse, etc.

Thus, a system and method involving a high voltage pulse generator and cooperating ignition cable can be utilized with traditional spark plugs to present a gas mixture with plasma streamers. Such plasma streamers accordingly couple with the gas mixture to create reactive species thereby enhancing efficiency of an engine performance.

In still other embodiments, the disclosed high voltage, fast rise, ultra-short pulse technology may be applicable to other applications of nanoseconds high-voltage pulses including, but not limited to, exhaust emission reduction, cancer treatment, pulsed electric fields form improving juice extraction and sterilization of agricultural products, and an approach to aerodynamic improvements in aircraft.

The various embodiments and examples described above are provided by way of illustration only and should not be construed to limit the claimed invention, nor the scope of the various embodiments and examples. Those skilled in the art will readily recognize various modifications and changes that may be made to the claimed invention without following the example embodiments and applications illustrated and described herein, and without departing from the true spirit and scope of the claimed invention, which is set forth in the following claims.

We claim:

1. A method for igniting air-fuel mixtures, comprising:
generating a fast rising voltage pulse;
creating a plurality of plasma streamers;
coupling the plasma streamers with an air-fuel mixture to create reactive species enhancing efficiency of combination chemistry.

2. The method of claim 1, further comprising providing a transient plasma plug assembly that generates the fast rising voltage pulse which creates the plasma streamers.

3. The method of claim 2, wherein the transient plasma plug includes built-in circuitry.

4. The method of claim 3, wherein the built-in circuitry includes a diode.

5. The method of claim 3, wherein the built-in circuitry includes a plurality of capacitors.

6. The method of claim 1, further comprising providing a compression line circuit that generates the fast rising voltage pulses cooperating to create the plasma streamers.

7. The method of claim 6, further comprising an ignition cable configured to transmit the fast rising voltage pulses generated by the compression line circuit.

8. The method of claim 7, wherein the ignition cable carries forward and return current such that peak electronic and magnetic fields are fixed over a length of the cable and includes electrical isolation for fixing effective capacitance.

9. The method of claim 7, wherein the cable is balanced and includes a third conductor.

10. The method of claim 1, further comprising producing the pulse of a nanosecond duration.

11. A system for igniting air-fuel mixtures of an engine, comprising:
a generator of a fast rising pulse, the generator creating a plurality of plasma streamers;
an air-fuel mixture; and
a circuit to effect a combination of the plurality of plasma streamers and the air-fuel mixture and creation of a reaction species enhancing efficiency of combustion chemistry of the engine.

12. The system of claim 11, further comprising a transient plasma plug assembly that generates the fast rising voltage pulse which creates the plasma streamers.

13. The system of claim 12, wherein the transient plasma plug includes built-in circuitry.

14. The system of claim 13, wherein the built-in circuitry includes a diode.

15. The system of claim 13, wherein the built-in circuitry includes a plurality of capacitors.

16. The system of claim 11, further comprising a compression line circuit that generates the fast rising voltage pulses cooperating to create the plasma streamers.

17. The system of claim 16, further comprising an ignition cable configured to transmit the fast rising voltage pulses generated by the compression line circuit.

18. The system of claim 17, wherein the ignition cable carries forward and return current such that peak electronic and magnetic fields are fixed over a length of the cable and include electrical isolation for fixing effective capacitance.

19. The system of claim 17, wherein the cable is balanced and includes a third conductor.

20. The system of claim 11, wherein the pulse has a nanosecond duration.

21. A spark plug, comprising:
a spark gap having a breakdown voltage; and
a transient plasma circuit that receives a signal from an external source and converts the signal into a high-voltage pulse having a rise time, the rise time of the pulse being less than the rise time of the signal from the external source, and less than the breakdown voltage of the spark gap, wherein the transient plasma circuit includes a first capacitor, a second capacitor, a diode, and a switch arranged such that transient plasma streamers are created when breakdown occurs across the spark gap.

22. The spark plug of claim 21, wherein the first and second capacitors are in parallel.

23. The spark plug of claim 22, wherein the diode is in parallel with the first capacitor, second capacitor, and the spark gap.

24. The spark plug of claim 21, wherein current flows through the first capacitor to ground and through the second capacitor and the diode to ground when the switch is open.

25. The spark plug of claim 21, wherein current flows from the first capacitor through the switch resonating with parasitic inductance when the switch is closed.

26. The spark plug of claim 25, wherein the resonating causes voltage across the second capacitor to add with inverted voltage of the first capacitor.

27. The spark plug of claim 21, wherein a resonant period of the first capacitor with parasitic inductance determines the rise time.

28. The spark plug of claim 21, wherein the switch is a spark gap that is distinct from the spark gap of the spark plug

29. The spark plug of claim 21, wherein the external source is an ignition coil.

30. The spark plug of claim 21, wherein the rise time of the high voltage pulse is less than 500 nanoseconds.

31. The spark plug of claim 21, wherein the rise time of the high voltage pulse is less than 100 nanoseconds.

32. A method for igniting air-fuel mixtures, comprising:
generating a fast rising voltage pulse;
creating a plurality of plasma streamers;
coupling the plasma streamers with an air-fuel mixture to create reactive species enhancing efficiency of combination chemistry to avoid a transition from transient plasma to a spark break down.
